(19) United States
(12) Patent Application Publication
(10) Pub. No.: US 2008/0008306 A1
(43) Pub. Date: Jan. 10, 2008

(54) Out of band messaging for completion of response to information request

(76) Inventor: Scott A. Kliger, Franklin, MI (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/823,831

(22) Filed: Jun. 28, 2007

Related U.S. Application Data
(60) Provisional application No. 60/818,083, filed on Jun. 30, 2006.

(51) Int. Cl. H04M 3/42

(52) U.S. Cl. 379/211.02

(57) ABSTRACT

A technique that allows an advertising supported information service to hand off a call in progress to another system, such as may be provided by a third party service provider, for all or part of the call. This permits the analysis of the results of a query, playback of an advertisement, read back of the requested telephone number, or call completion, etc. by third party system(s).

### RELATED APPLICATION(S)

This application claims the benefit of U.S. Provisional Application No. 60/818,083, filed on Jun. 30, 2006. The entire teachings of the above application are incorporated herein by reference.

### BACKGROUND OF THE INVENTION

There continues to be a great demand for telephone directory assistance services. Nearly all directory assistance calls that are placed by consumers are those looking for a telephone number for a specific business or individual. These services have become a very large revenue center for both wired and wireless telephony carriers, with very high profit margins. Consumers are often charged one dollar ($1 U.S.) or more for such calls.

Certain alternatives to traditional pay per call (PPC) directory assistance have recently emerged. One such system is described in U.S. Patent Publication No. 2006/0171520, filed as application Ser. No. 11/291,094, on Nov. 29, 2005, entitled “Telephone Search Supported by Key Word Map to Advertising,” by Scott A. Kliger, which application is incorporated by reference herein in its entirety. Such a service is supported by dynamically targeted, and even interactive, audio advertisements that are played in response to a consumer initiated request for information.

In a typical embodiment of that system, a consumer dials an information access telephone number and is connected to a information service, i.e., “411”, or other call processing system. The call processing system receives a verbal request for information from the consumer and determines a response. For example, an Interactive Voice Response (IVR) system or human operator can examine the request for the presence or one or more keywords. The keyword(s) are then used to determine a subject matter area associated with the request, and an advertisement categorized within the associated subject matter area is identified. The selected advertisement can then be retrieved as a stored audio file or as a text file that is converted to audible speech such as a through a Text To Speech (TTS) system, or as a text file that is displayed and read back to the consumer by human operator. As a result, this type of system can be used to provide an alternative to Pay Per Call (PPC) services that supports a “free to consumer” yellow or white pages directory search.

### SUMMARY OF THE INVENTION

The present invention is an adaptation of the free to consumer directory information system described in the above-referenced patent publication. Specifically, the present invention allows the advertising supported information service to hand off a call in progress to another system, such as may be provided by a third party service provider, for all or part of the call. This permits the analysis of the results of a query, playback of an advertisement, read back of the requested telephone number, or call completion, etc. by third party system(s).

Moreover, assuming that the original call placed by the consumer occurs in-band on a telephony channel, a problem exists in that the in-band channel is being used to carry audio. There is no data channel to communicate the result of the query to or from a third party, or to perform other parts of the service.

The present invention resolves this problem by proceeding as follows. The information service sends an Out of Band (OOB) message over another network connection. This connection may be provided by Short Messaging Service (SMS), or in a preferred embodiment, Hypertext Transfer Protocol (HTTP) over a TCP/IP connection such as via a PUT message. The OOB message contains a query string and/or other instructions for the third party. In one embodiment, the third party may be an advertising service. The advertising service receives the query and analyzes it either for example, to select an ad. The third party system then bridges the call and plays back the ad using a Text To Speech (TTS) system local to the third party service.

In other aspects of the invention, since the communication between the information service and the advertising service is out of band, there must be a way of uniquely identifying the call so that the correct ad is played back (or other information associated with) to correct caller on the correct in-band channel.) Unfortunately, caller ID or ANI information is not sufficient since two callers from the same Private Branch exchange (PBX) or a carrier who sets the caller ID can in fact call at the same time.

Thus, the present invention allows for setting the ANI on the bridge between the information service automation platform and the third party service to a unique ID parameter. The unique ID parameter may be between four and up to the full ten digits of the ANI. The ID uniquely identifies the call so that the match can be made when the number is returned to the advertising service.

A data channel/protocol can be provided between the callers using the same approach.

As an optional step, the advertising service can then also provide information back to the information service, again identified by the unique ID.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a block diagram of a system that delivers dynamically targeted audio advertisements in response to a consumer initiated request for information.

FIG. 2 is a flow chart of steps performed by the system to select and play back an audio advertisement.

FIG. 3 is a detailed view of a message that can be sent between an information service and an advertising service.

### DETAILED DESCRIPTION OF THE INVENTION

A description of preferred embodiments of the invention follows.

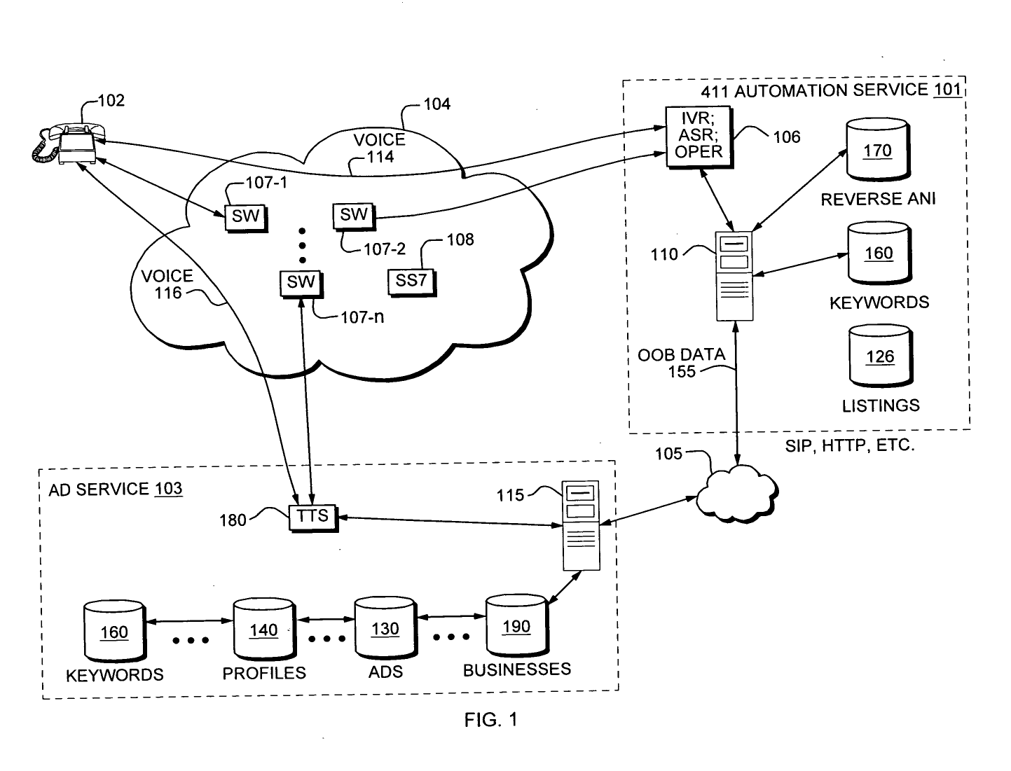

With reference to FIG. 1, the invention can be implemented using an automated information service (i.e., one that provides “411” directory information) 101 that uses a server 110 which can receive information originating from a Public Switched Telephone Network (PSTN) 104, specifically via a call originating from a consumer who is using a telephone 102.

The server 110 can receive information requests and respond in many ways. In one preferred arrangement, the information is provided as audio signals to an Interactive Voice Response (IVR)/Automated Voice Recognition (AVR) system 106. The IVR portion of 106 has some type of interface to obtain a search request from the user, and provide the request as data output. For example, the information request can be provided in data form via a keypad (Dual Tone Multi-Frequency (DTMF) digits), by providing it via a text message (such as via a Short Message Service (SMS)) by voice recognition software that recognizes speech, and/or via a live operator who speaks to the consumer live and then keys in the request as text. The AVR portion of system 106 provided automatic recognition of the voice signals provided by the consumer.

The server 110 for information service 101 is connected through the Internet (and/or local networks) to various other databases and/or information servers. These include, for example, databases that are local to the application server 110 such as a listings database 120, keyword database 160 and for a reverse Automatic Number Identifier (ANI) database 170. Other databases and/or services may be remotely located and accessible through a third party service, such as an ad server 103, a consumer profile database 140, a business listings database 190. Other paid-subscription or free services or databases can also be available through another application server 115 associated with an advertising service 103.

FIG. 1 should be considered as but one possible logical view of the various databases; that is, although the drawings illustrates these databases as individual discrete entities each having their own server, it should be understood that one, several, or all of the databases may be consolidated in one physical machine, or that one or more of the databases may be so large as to be distributed among multiple servers and physical processors and/or disk drives. It should also be understood that listing database 120, keywords database 16, and/or reverse ANI database 170 may be resident on ad service 103 or elsewhere in an accessible network 105.

In general, the application server 110 crafts a search query from the information supplied by the consumer via the telephone 102. The results of the search query are then submitted to the ad service 103. More particular, in one embodiment, the server 110 takes the consumer request, such as for a directory listing, and submits it to private listings database 120. The listings database 120 contains information concerning advertisers who have paid a fee to be listed in the system or agreed to pay for each call which is directed to them as the result of a consumer inquiry.

For example, if the search request comes in on a particular telephone number, that telephone number can then be used to obtain a location of the calling telephone 102. This location can then be combined with the category of the search request as a submission to the listings 120 database.

Also note that the listings database 120 is not necessarily limited to just having a list of businesses as grouped into categories by a local telephone exchange service provider. For example, custom groupings may be determined by the system provider, such as by grouping businesses by their telephone number, or other combinations without regard to specific, predefined business or services categories.

Another database that may be kept is a keywords database 160. As will be understood below, the keywords database is used to further refine selection of an advertisement when the consumer's initial request does not map directly to a listing and/or category in the listings database 120. The keywords database 160 may be located several different places, such as a separate database 160, or it may be part of the listings 120 or business database 190, or part of the server 110 or 115 itself.

A successful query in the listings database 120 or keyword 160 identifies information that is sent to ad service 103 to select one or more telephone numbers associated with one or more requests by the consumer 102. Typically, the requested number correlates to a selected ad to be played, based on a number of criteria such as which advertiser bid the most for the ad, or which advertiser provides the best offer to the consumer, etc.

The identified ad is then played back from ad service 103. The consumer then hears the advertising message(s) in response to her search request. The ads may be stored as digitally encoded audio files (MP3, WAV, etc.) or as text files. In the case of digitally encoded audio file, they are played back to the consumer 102 as an audio signal. However, if stored as a text file, they may first be processed through Text to Speech (TTS) equipment 180, or alternatively, displayed on the users device (e.g., from a reply SMS message).

The application server 115 (in ad service 103) can also access a business database 190 which may be hosted by another service provider, for example as a paid service, to locate information that is not in the listings database 120. The business database query 190 can be used, for example, to provide general information listings responsive to the user's request, as further means to select an ad or information to play back.

As for the case of the listings database 120, the location of the caller can be determined by making a query to the reverse ANI database 170 prior to querying the listings database 120. (Please note that the standard ANI service provides information concerning the calling parties' telephone number, such as might also be determined from the phone number portion of a “caller ID” determination, although ANI is not the same service as caller ID in the United States.)

Further information may be maintained in a consumer profile database 140 that is kept on a per telephone number basis. Such information may include, but is not limited to, data indicating past queries and responses to those inquires. It should be understood that other identifiers may be used to specify a particular individual consumer. For example, the system may keep data on a home phone number, a mobile phone number, and an office phone number together with a unique identifier for the individual. This may also be beneficial as many people now use more than one number.

More particularly now, note that if the ad service 103 is used to look up and play back the advertisement, this is done through the expedient of setting up a conference bridge through network 104 such that TTS 180 in ad service 103 can play back an audio signal on the same connection as the original voice call between consumer telephone 102 and information service 101. The original voice call 114 was set up through network 104 by creating a connection through switches 107-1, 107-2, 107-n such as through a Signaling System 7 (SS7) controller 108.

However, in order for ad service 103 to locate an ad by analyzing the request, it must first somehow receive the request. iAssuming that the original request is made via a telephone calls through network 104 and made in band on a voice telephony channel, there is no data channel to communicate the result of the search by information service 101. In accordance with the present invention, the information service 101 sends an Out of Band (OOB) message over some means such as a Session Initiated Protocol (SIP) connection, or as an HTTP PUT message with a query string, to the ad service 103 through a separate network 105.

The ad service 103 then receives the request and analyzes it for whatever purpose. For example, after lookup in a listings database 120, the request may be used to select an ad from ad database 130. The lookup for an ad can also possibly use profiles database 140 and/or businesses database 190.

The ad is then played back to the consumer 102 using the TTS 180 or read by a live operator associated with ad service 103 over a bridged connection 116.

However since the OOB connection to pass data 150 is not on network 104, there needs to be a way of uniquely identifying the original call 114 such that the correct number is played back and the correct ad is played back to the correct caller and in-band on the bridged voice connection 116. Since two callers 102 may originate from the same (PBX or carrier who sets the caller ID), then caller ID and/or ANI alone are insufficient. Thus, the present invention sets the ANI on the conference bridge a unique ID which may be for example between four and ten digits of the ANI. This ID then identifies the call so that a match can be made to connect original call 114 and bridged connection 116 when needed.

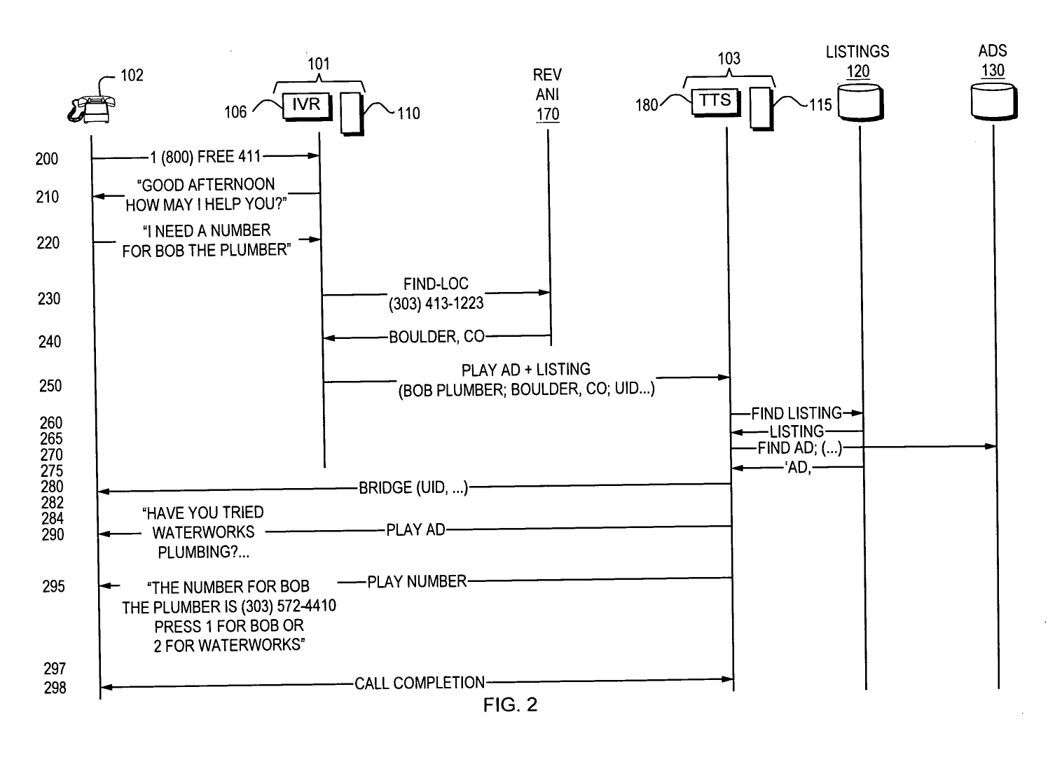

FIG. 2 is a more detailed flow chart of the process involved.

In a first step 200, a call is made from consumer 102 telephone to the information service 101. The information service, as on example, can prompt the caller:

“Good afternoon, how may I help you?”

In a next step 220, a consumer replies:

“I need a number for Bob the Plumber”

At this point, the information service 101 can optionally find a current location of the caller. It does so by doing a lookup of the caller's ANI. For example, in the reverse ANI database 170. The reverse ANI database 170 returns Boulder, Colorado for the caller's location. This location is used by information service 101 to perform a look up in listings database 120 to obtain “Bob the Plumber's” telephone number. This information can then be forwarded from the information service 101 to the advertising service 103 providing the information request (i.e., “Bob the Plumber”), the location (i.e., “Boulder, Colorado”), and a unique user ID assigned to the call, all on the OOB data connection 150.

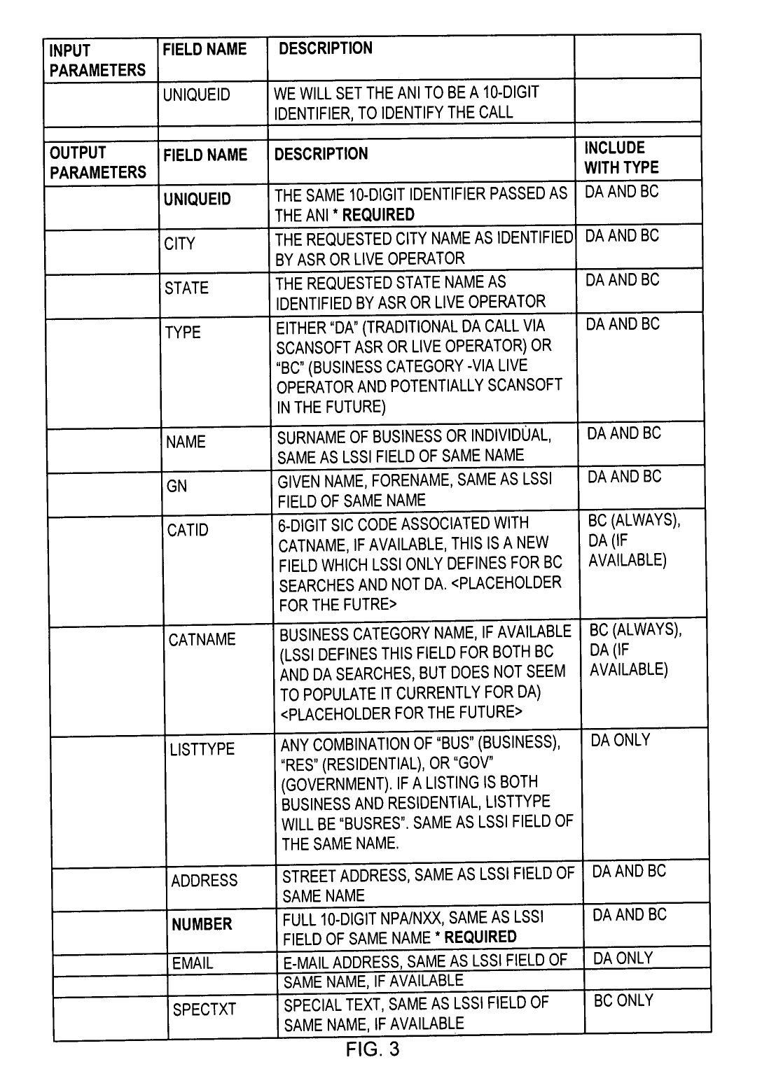

The format of this message may be as illustrated in FIG. 3 or other formats.

Upon receipt of this information at advertising service 103, if a listing has not been provided by the information service 101, then a next step 260 is to locate an advertisement relevant to the requested listing such as by performing a lookup in listings database 120, or keyword database 160 (if not provided by information service 101). It should be understood that the listings lookup can be performed by the advertising service 103 or may be local to the information service 101. In any event, an advertisement is located by step 275. This advertisement must then be played back. Since the advertising service 103 has been provided with a unique ID, then the unique ID can be presented with a request to bridge both the information service 101 and caller 102 telephony connection 114 and 116. In this manner, the network 104 can identify the trunk to which the call from TTS 180 is to be bridged. Thus by step 284, a conference bridge has been established between the TTS 180 in ad service 103, the IVR 106 in information services 101, and the original consumer 102. The advertisement can then be played back in step 290, in this instance:

“Have you tried Waterworks Plumbing? We have twenty five experience in solving customer problems.”

In step 295, the requested number can be played back, also by ad service 103:

“The number you requested, for Bob the Plumber, is (303)-572-4410.”

Further prompting can be provided by the TTS 180 at this point, to further process the call. It can prompt with, for example:

“Press 1 for Bob the Plumber or 2 for Waterworks.”

In step 298, call completion can take place between the original caller 102 and the requested contact (Bob or Waterworks), as selected by the user.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method comprising the steps of:
at a customer station, placing a call over a first connection from the customer station to an advertising supported information service, the call containing a request for information;
at the information service, analyzing the request for information to determine parameters of the request for information;
sending an Out of Band (OOB) message over a second connection to a third party advertising message service, the OOB message containing a query string that depends on the parameters determined from the request for information; and
at the third party advertising service, analyzing the query string in the OOB message to determine an advertising message to be played.

2. A method as in claim 1 additionally comprising:
bridging the first connection so that the customer station can receive the advertising message.

3. A method as in claim 2 additionally comprising the steps of:
assigning a unique identifier for the call made over the first connection;
and wherein the Out of Band (OOB) message sent over a second connection to a third party advertising message service also contains the unique identifier; and
at the third party advertising service,
using the unique identifier for the call, bridging to the first connection so that the customer station can receive the advertising message.

4. A method as in claim 1 wherein the request for information is provided as an audio signal.

5. A method as in claim 1 wherein the advertising message is provided as an audio signal.

6. A method as in claim 1 wherein the request for information is provided as a data string.

7. A method as in claim 1 wherein the request for information is provided from a Short Message Service (SMS) text message by the user.

8. A method as in claim 1 wherein the advertising message is provided as a text string.

9. A method as in claim 1 additionally comprising:
providing the advertising message to the calling station.

10. An apparatus comprising:
(a) a customer station, for placing a call over a first connection from the customer station to an advertising supported information service, the call containing a request for information;
(b) an information service, for
(i) analyzing the request for information to determine parameters of the request for information; and
(ii) sending an Out of Band (OOB) message over a second connection to a third party advertising message service, the OOB message containing a querystring that depends on the parameters determined from the request for information; and
(c) a third party advertising service, for analyzing the query string in the OOB message to determine an advertising message to be played.

11. An apparatus as in claim 10 wherein the information service additionally bridges the first connection so that the customer station can receive the advertising message.

12. An apparatus as in claim 11 wherein the information service additionally assigns a unique identifier for the call made over the first connection; and wherein the Out of Band (OOB) message sent over a second connection to a third party advertising message service also contains the unique identifier.

13. An apparatus as in claim 12 wherein the third party advertising service, uses the unique identifier for the call to bridge to the first connection so that the customer station can receive the advertising message.

14. An apparatus as in claim 10 wherein the request for information is provided as an audio signal.

15. An apparatus as in claim 10 wherein the advertising message is provided as an audio signal.

16. An apparatus as in claim 10 wherein the request for information is provided as a data string.

17. An apparatus as in claim 10 wherein the request for information is provided from a Short Message Service (SMS) text message by the user.

18. An apparatus method as in claim 10 wherein the advertising message is provided as a text string.

19. An apparatus as in claim 10 wherein the advertising service additionally provides the advertising message to the calling station.
